(19) United States
(12) Patent Application Publication
(10) Pub. No.: US 2010/0215063 A1
(43) Pub. Date: Aug. 26, 2010

(54) PULSE LASER APPARATUS

(75) Inventors: Xin GAO, Hamamatsu-shi (JP); Hiroyuki Ohashi, Hamamatsu-shi (JP); Kazunori Shinoda, Hamamatsu-shi (JP); Hiroshi Okamoto, Hamamatsu-shi (JP); Masayuki Saitoh, Hamamatsu-shi (JP)

Correspondence Address: DRINKER BIDDLE & REATH (DC), 1500 K STREET, N.W., SUITE 1100, WASHINGTON, DC, 20005-1209, US

(73) Assignee: HAMAMATSU PHOTONICS K.K., Hamamatsu-shi (JP)

(21) Appl. No.: 12/686,637

(22) Filed: Jan. 13, 2010

(30) Foreign Application Priority Data
Feb. 25, 2009 (JP) P2009-042347

(51) Int. Cl. H01S 3/11

(52) U.S. Cl. 372/11

(57) ABSTRACT

The pulse laser light source 1 is provided with an excitation light source 10, lenses 11 through 13, a dichroic mirror 14, an amplifier medium 21, a first reflection portion 22, a laser medium 23, a third reflection portion 24, a saturable absorber 25 and a second reflection portion 26. The reflection portion 22 and the reflection portion 26 compose a laser resonator having the laser medium 23, the reflection portion 24 and the saturable absorber 25 on a resonance path. Further, the amplifier medium 21, the reflection portion 22, the laser medium 23, the reflection portion 24, the saturable absorber 25 and the reflection portion 26 are disposed in order and are integrated with each other. Therefore, the pulse laser light source 1 is able to output pulse laser light of high energy with a short pulse width.

### BACKGROUND OF THE INVENTION

1. Field of the Invention

The present invention relates to a pulse laser apparatus.

2. Related Background Art

The pulse laser apparatuses described in, for example, Japanese Translation of International Application (Kohyo) No. H9-508755, Japanese Published Unexamined Patent Application No. H11-261136, and Japanese Published Unexamined Patent Application No. 2006-73962 have been known as a prior art pulse laser light source. These pulse laser light sources are configured to have a laser medium for generating emission light by excitation light being supplied and a saturable absorber operating as a passive Q switch, the light absorption ratio of which decreases by saturation of light absorption on a resonance light path of a laser resonator.

In a pulse laser light source having a laser resonator constructed as described above, the pulse width of pulse laser light output is generally 500 ps to several nanoseconds. The pulse width is determined by the configuration of the laser resonator. The resonator length is one of the important parameters to determine the pulse width. Where it is desired that the pulse width is shortened, it is necessary to shorten the length of the resonator.

### SUMMARY OF THE INVENTION

However, shortening of the resonator length results in shortening of the lengths of a laser medium and a saturable absorber, wherein an inconsistency is brought about between the shortening thereof and the laser oscillation characteristics. That is, if the laser medium is shortened, it becomes difficult to obtain sufficient absorption (excitation) to inverted distribution necessary to oscillate a laser, and the energy of output pulse laser light is lowered. In addition, if the saturable absorber is shortened, the Q switch function is weakened to widen the pulse width and to lower the output pulse energy, wherein desired laser characteristics are not able to be obtained.

The present invention was developed in order to solve the above-described problems, and it is therefore an object of the present invention to provide a pulse laser apparatus capable of outputting pulse laser light of high energy at a short pulse width.

In order to achieve the above-described object, a pulse laser apparatus according to the present invention is featured in that the pulse laser apparatus includes: (1) an amplifier medium and a laser medium, which generate emission light by excitation light being supplied; (2) a saturable absorber, the light absorption index of which decreases by saturation of light absorption; (3) a first reflection portion for causing the excitation light to pass therethrough, causing a part of the emission light to pass therethrough, and reflecting the remaining thereof; (4) a second reflection portion for reflecting the emission light; (5) an excitation light source for outputting excitation light; and (6) an optical system for making excitation light, which is output from the excitation light source, incident into the amplifier medium, and guiding the emission light output from the amplifier medium to an optical path differing from the optical path of the excitation light. Further, the pulse laser apparatus according to the present invention is featured in that the first reflection portion and the second reflection portion configure a laser resonator having a laser medium and a saturable absorber on a resonance optical path, and the amplifier medium, the first reflection portion, the laser medium, the saturable absorber, and the second reflection portion are disposed in order and are integrated with each other.

In the pulse laser apparatus, excitation light output from an excitation light source is made incident into an amplifier medium and further incident into a laser medium, wherein the amplifier medium and the laser medium are excited. Emission light generated in the laser medium located on a resonance optical path of a laser resonator composed between the first reflection portion and the second reflection portion is able to reach a saturable absorber. When the power of the emission light generated in the laser medium is small, the light absorption index of the saturable absorber is intense, and no laser oscillation occurs in the laser resonator. As the power of the emission light generated in the laser medium is increased, and the optical intensity in the saturable absorber exceeds a specified value, light absorption of the saturable absorber is saturated, and the light absorption index is rapidly decreased. When the light absorption index of the saturable absorber is decreased, the emission light generated in the laser medium is able to pass through the saturable absorber, and causes induced emission in the laser medium. Therefore, laser oscillation occurs in the laser resonator.

It is preferable that the pulse laser apparatus according to the present invention is further provided with a third reflection portion that is installed between the laser medium and the saturable absorber, reflects excitation light and causes the emission light to pass therethrough. In this case, since the excitation light is reflected by the third reflection portion, the excitation light is prevented from passing through the saturable absorber, wherein a problem of heat generation of the saturable absorber is prevented.

In the pulse laser apparatus according to the invention, the first reflection portion is composed of a dielectric multilayer film, and it is preferable that the amplifier medium and the laser medium are direct-bonded to each other with the first reflection portion placed therebetween. In this case, it is favorable in that the amplifier medium and the laser medium are integrally connected to each other.

It is preferable that the pulse laser apparatus according to the present invention is further provided with a heat diffusion portion for diffusing heat generated by light absorption in the amplifier medium or the laser medium. In this case, since heat generated in the amplifier medium or the laser medium is diffused by the heat diffusion portion, the heat lens effect can be prevented from occurring, wherein stable operation is brought about.

In the pulse laser apparatus according to the present invention, it is preferable that the amplifier medium has an excitation light absorbing property depending on the polarization direction of excitation light, or the laser medium has an excitation light absorbing property depending on the polarization direction of excitation light. Further, it is preferable that the optical system has a polarization adjustment portion for adjusting the polarization state of excitation light output from the excitation light source and made incident into the amplifier medium. In these cases, since the polarization state of the excitation light is adjusted by the polarization adjustment portion, the pulse cycle of the laser oscillation and energy of the pulse laser light can be modulated.

### BRIEF DESCRIPTION OF THE DRAWINGS

FIG. 1 is a view showing a configuration of a pulse laser light source according to the first embodiment;

FIG. 2 is a view describing a first mode of direct bonding of an amplifier medium and a laser medium in the pulse laser light source according to the first embodiment;

FIG. 3 is a view describing a second mode of direct bonding of an amplifier medium and a laser medium in the pulse laser light source according to the first embodiment;

FIG. 4 is a view describing a third mode of direct bonding of an amplifier medium and a laser medium in the pulse laser light source according to the first embodiment;

FIG. 5 is a view showing a configuration of a pulse laser light source according to the second embodiment;

FIG. 6 is a view showing a configuration of a pulse laser light source according to the third embodiment;

FIG. 7 is a view showing a configuration of a pulse laser light source according to the fourth embodiment; and

FIG. 8 is a view showing a configuration of a pulse laser light source according to the fifth embodiment.

### DESCRIPTION OF THE PREFERRED EMBODIMENTS

Hereinafter, a detailed description is given of embodiments of the present invention with reference to the accompanying drawings. In addition, in the description of the drawings, components that are identical to each other are given the same reference numerals, and overlapping description is omitted.

### First Embodiment

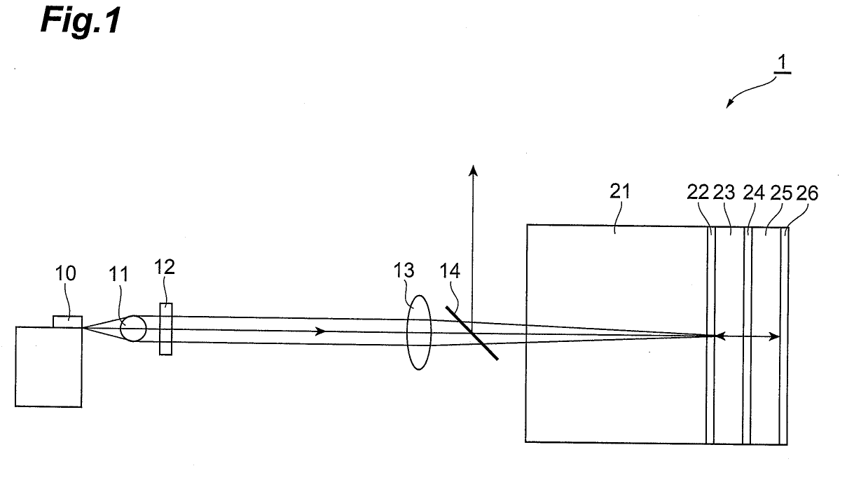

FIG. 1 is a view showing a configuration of a pulse laser apparatus 1 according to the first embodiment. The pulse laser apparatus 1 shown in the drawing is provided with an excitation light source 10, lenses 11 through 13, a dichroic mirror 14, an amplifier medium 21, a first reflection portion 22, a laser medium 23, a third reflection portion 24, a saturable absorber 25 and a second reflection portion 26.

The amplifier medium 21 and the laser medium 23 contain a photoactive substance, respectively, and the photoactive substance is excited by supplying excitation light output from the excitation light source 10, wherein emission light is emitted from the photoactive substance. It is preferable that the amplifier medium 21 and the laser medium 23 are crystal such as Nd:YAG and Yb:YAG, etc., respectively. The thickness of the amplifier medium 21 is, for example, 0.2 mm through 1.5 mm. The thickness of the laser medium 23 is, for example, 0.01 mm through 1.5 mm.

The saturable absorber 25 is such that the light absorption index decreases by saturation of light absorption, and is used as a passive Q switch in a laser resonator. That is, in the saturable absorber 25, the light absorption index is large when the light intensity is small, and when the light intensity exceeds a specified value, the light absorption is saturated, and the light absorption index rapidly is decreased. It is preferable that the saturable absorber 25 is crystal such as Cr:YAG, etc.

The reflection portion 22 is provided between the amplifier medium 21 and the laser medium 23. The reflection portion 22 causes excitation light to pass therethrough and causes a part of the emission light to pass therethrough and reflects the remaining thereof. The reflection index of the reflection portion 22 at the emission light wavelength is, for example, 90% or so. It is preferable that the reflection portion 22 is composed of a dielectric multilayer film.

The reflection portion 24 is provided between the laser medium 23 and the saturable absorber 25. The reflection portion 24 reflects excitation light and causes emission light to pass therethrough. It is preferable that the reflection portion 24 is composed of a dielectric multilayer film.

The reflection portion 26 is provided on the side opposed to the side where the reflection portion 24 is provided in the saturable absorber 25. The reflection portion 26 reflects emission light at a high reflection index. It is preferable that the reflection portion 26 is composed of a dielectric multilayer film.

The reflection portion 22 and the reflection portion 26 compose a laser resonator having the laser medium 23, the reflection portion 24 and the saturable absorber 25 on a resonance optical path. Also, the amplifier medium 21, the reflection portion 22, the laser medium 23, the reflection portion 24, the saturable absorber 25 and the reflection portion 26 are disposed in order and are integrated with each other. When being integrated, these components are connected to each other by direct bonding (surface-activation junction technique).

Further, it is preferable that a permeation portion for permeating excitation light and emission light at a high transmission index is provided at the excitation light incidence side of the amplifier medium 21. Still further, it is preferable that the permeation portion is composed of a dielectric multilayer film.

The excitation light source 10 outputs excitation light to excite a photoactive substance contained in the amplifier medium 21 and the laser medium 23, respectively. It is preferable that the excitation light source 10 includes a laser diode.

The optical system including lenses 11 through 13 and a dichroic mirror 14 provided between the excitation light source 10 and the amplifier medium 21, causes the excitation light, which is output from the excitation light source 10, to be made incident into the amplifier medium 21, and guides the emission light, which is output from the amplifier medium 21, to an optical path differing from the optical path of the excitation light.

Where a laser diode is used as the excitation light source 10, the excitation light output from the laser diode has a fast axis and a slow axis, wherein the spread angles thereof differ depending on the axial directions. Therefore, the excitation light output from the laser diode is input into two lenses 11 and 12, and collimated excitation light is output therefrom.

The lens 13 has the collimated excitation light input thereinto, converges the excitation light and condenses the light on the laser medium 23. Therefore, the energy density of the excitation light at the laser medium 23 is increased to make it easy to shorten the pulse width.

The dichroic mirror 14 transmits the excitation light output from the excitation light source 10 and reached through the lenses 11 via 13, and makes the excitation light incident into the amplifier medium 21. The dichroic mirror 14 reflects the emission light output from the amplifier medium 21 and reached there and guides the emission light to an optical path differing from the optical path of the excitation light.

The pulse laser light source 1 according to the first embodiment operates as follows. The excitation light output from the excitation light source 10 is collimated by two lenses 11 and 12 and is converged by the lens 13, and is made incident into the amplifier medium 21 after permeating the dichroic mirror 14. The excitation light made incident from the dichroic mirror 14 into the amplifier medium 21 passes through the amplifier medium 21, the reflection portion 22 and the laser medium 23 in order and reaches the reflection portion 24, and the excitation light is reflected by the reflection portion 24. The excitation light reflected by the reflection portion 24 passes through the laser medium 23, the reflection portion 22 and the amplifier medium 21 in order. In the amplifier medium 21 and the laser medium 23, respectively, the photoactive substance is excited when the excitation light passes therethrough.

In the laser resonator, the emission light generated in the laser medium 23 excited by the excitation light passes through the reflection portion 24 and is able to reach the saturable absorber 25. When the power of the emission light generated in the laser medium 23 is small, the optical absorption index of the saturable absorber 25 is large, and no laser oscillation occurs in the laser resonator. As the power of the emission light generated at the laser medium 23 is increased and the light intensity in the saturable absorber 25 exceeds a threshold value, the optical absorption of the saturable absorber 25 is saturated, and the optical absorption index is decreased. When the optical absorption index of the saturable absorber 25 is reduced, the emission light generated in the laser medium 23 can pass through the saturable absorber 25 and is reciprocated between the reflection portion 22 and the reflection portion 26, wherein induced emission is brought about in the laser medium 23. Therefore, laser oscillation occurs in the laser resonator.

The light (laser light), which has passed through the reflection portion 22, of the induced emission light generated in the laser medium 23 is optically amplified in the amplifier medium 21 excited by the excitation light when passing through the amplifier medium 21. And, the optically amplified laser light is emitted outside from the amplifier medium 21, and is reflected by the dichroic mirror 14. Also, as soon as such laser oscillation is brought about, the power of the emission light generated in the laser medium 23 is decreased, and the optical absorption index of the saturable absorber 25 is increased, wherein the laser oscillation is finished in the laser resonator. By the above operation being repeated, the pulse laser light source 1 is able to output the pulse laser light.

In this connection, a semiconductor and crystal may be used as the saturable absorber. However, where a semiconductor is used as the saturable absorber, there is a problem in actual applications because the optical absorption is large and the heat generation is also large. On the contrary, in the pulse laser light source 1 according to the present embodiment, crystal is adopted as the saturable absorber. A crystal type saturable absorber is preferable in actual applications because there are only a few thermal problems although the absorption index thereof is small in comparison with the semiconductor type saturable absorber.

However, it is necessary that the absorption length of the crystal type saturable absorber is lengthened to supplement a small absorption index, and the resonator length is lengthened. Therefore, there is a limit in shortening the pulse. Accordingly, as the pulse laser light source in which the crystal type saturable absorber is used, there is no product in which the pulse width of output pulse laser light is shorter than 500 ps and a high output is reached.

In the present embodiment, in order to achieve high output with a short pulse width, it is attempted that by shortening the laser medium 23 while securing an absorption length of the saturable absorber 25, a short pulse is brought about with the resonator length controlled, and high output is concurrently brought about.

Also, the pulse laser light source 1 according to the present embodiment is featured in that the laser light output from the excitation light source 10 is supplied to the laser medium 23 after having passed through the amplifier medium 21. With such a configuration, since a part of the excitation light is absorbed in the amplifier medium 21 before reaching the laser medium 23, at a glance it may be considered that this is disadvantageous in terms of high output. However, the pulse laser light source 1 according to the present embodiment has a configuration based on turning the idea upside down with respect to such a consideration.

That is, since, it is configured, in the pulse laser light source 1 according to the present embodiment, that the laser medium 23 the absorption length of which seems insufficient at a glance is disposed in the resonator in order to shorten the pulse, and the reflection portion 24 that reflects excitation light and causes emission light to pass therethrough is disposed between the laser medium 23 and the saturable absorber 25, the excitation light that cannot be completely absorbed by one pass is reflected by the reflection portion 24, the laser medium 23 is excited by two passes, thereby causing efficient laser oscillation to occur, and the laser light is made incident into the amplifier medium 21 disposed so as to precisely prevent excitation with respect to the laser medium 23.

It is preferable that the laser medium 21 and the amplifier medium 23 are physically connected to each other in order to sufficiently match the space modes of the excitation light and the emission light to each other. Also, since the laser medium 21 and the amplifier medium 23 are integrally connected to each other, there is another advantage by which a thermal lens effect can be prevented from occurring while suppressing mechanical deformation of the laser medium 23. If not integrally connected to each other, a problem occurs in the mechanical characteristics and the mount. If crystals are mechanically pressed to each other, stress may be brought about in the interior of the crystals, and the refractive index distribution may be adversely influenced, wherein the stability of laser oscillation and the oscillation mode are adversely influenced, and positioning thereof becomes cumbersome. If disposed in proximity to each other, it becomes necessary to carry out alignment, and the space modes described above are brought into mismatch, wherein the amplifier efficiency will be remarkably lowered. Therefore, in the pulse laser light source 1 according to the present embodiment, the laser medium 21 and the amplifier medium 23 are physically and integrally connected to each other.

Several methods have been known as the direct bonding technique of glass and crystals. For example, diffusion junction and optical contact have been well known. In addition, although an adhesive agent may be used for adhesion, the adhesive agent is not proper because the adhesive agent may cause damage in a case of a high output laser.

The diffusion junction is thermal junction by which substances are mutually diffused for junction by application of high temperature. However, since the dielectric multilayer film used as the reflection portion 22 is weak against heat, the diffusion junction is physically impossible.

The optical contact is a technique by which junction is carried out through generation of between-particle forces by improving the flatness and surface roughness to the extreme. Therefore, unless substances have such flatness and surface roughness by which between-particle forces can be brought about, no junction is possible. There may remain a possibility of disengagement or separation. Generally, although there is a possibility for optical contact to be established between a dielectric multilayer film and crystals or optical contact between dielectric multilayer films to be established under a definite condition, it is difficult to establish the optical contact and there may remain concerns about the occurrence of troubles.

Accordingly, in the pulse laser light source 1 according to the present embodiment, such problems can be solved by adopting a surface-activating junction technique (direct bonding) the research of which has been advanced in the field of MEMS (Micro Electro Mechanical Systems) in recent years. The surface-activating junction technique has been developed in the field of MEMS in order to execute junction between silicon substrates. The direct bonding is possible for junction between crystal and a dielectric film, and for junction between dielectric films.

In the pulse laser light source 1 according to the present embodiment, as the condition of direct bonding, the surface state of crystal or dielectric multilayer film is preferably equal to or smaller than λ (further preferably equal to or smaller than λ/10) with respect to the flatness and is preferably equal to or smaller than 1 nm (further preferably equal to or small than 0.5 nm) with respect to the surface roughness Ra.

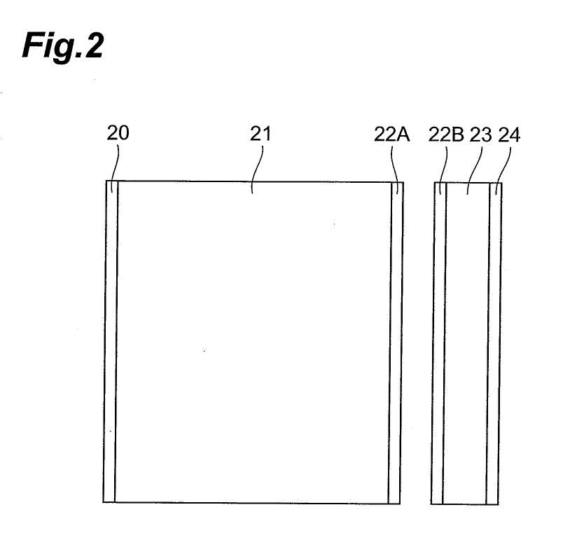

FIG. 2 through FIG. 4 are views describing modes of direct bonding between the amplifier medium 21 and the laser medium 23 in the pulse laser light source 1 according to the present embodiment.

In the first mode of direct bonding shown in FIG. 2, a permeation portion 20 is formed on one of the two main sides, which are parallel to each other, of the amplifier medium 21, and the reflection portion 22A is formed on the other main side thereof. The reflection portion 24 is formed on one of the two main sides, which are parallel to each other, of the laser medium 23, and the reflection portion 22B is formed on the other main side thereof. And, the amplifier medium 21 and the laser medium 23 are subjected to direct bonding in a state where the reflection portion 22A and the reflection portion 22B are placed therebetween, and the reflection portions 22A and 22B are turned into the reflection portion 22 after they are directly bonded to each other.

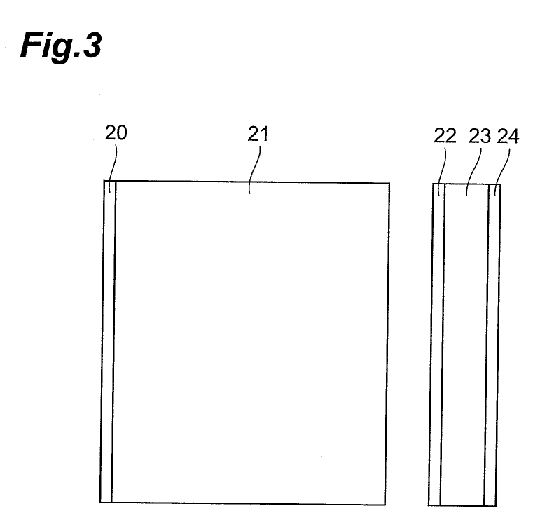

In the second mode of the direct bonding shown in FIG. 3, the permeation portion 20 is formed on one main side of the two main sides, which are parallel to each other, of the amplifier medium 21. The reflection portion 24 is formed on one main side of the two main sides, which are parallel to each other, of the laser medium 23, and the reflection portion 22 is formed on the other main side thereof. And, the amplifier medium 21 and the laser medium 23 are directly bonded to each other with the reflection portion 22 placed therebetween.

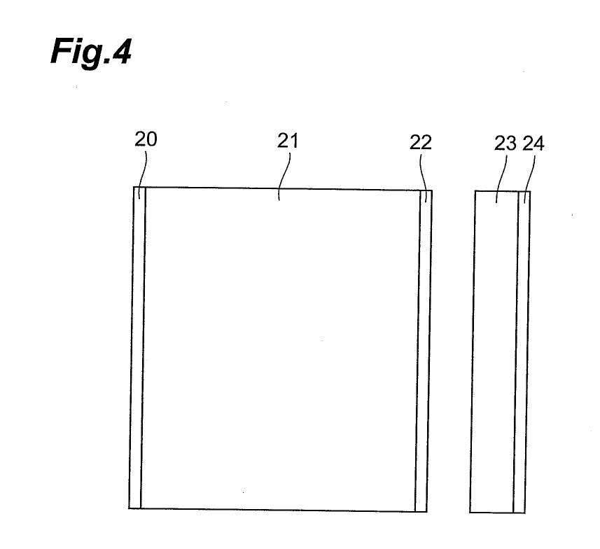

In the third mode of the direct bonding shown in FIG. 4, the permeation portion 20 is formed on one of the two main sides, which are parallel to each other, of the amplifier medium 21, and the reflection portion 22 is formed on the other main side thereof. The reflection portion 24 is formed on one of the two main sides, which are parallel to each other, of the laser medium 23. And, the amplifier medium 21 and the laser medium 23 are directly bonded to each other with the reflection portion 22 placed therebetween.

In any of these cases, it is preferable that the extreme surface layer of the reflection portion 22A, the reflection portion 22B or the reflection portion 22 before direct bonding is composed of an SiO₂ layer the surface roughness Ra of which is small.

### Second Embodiment

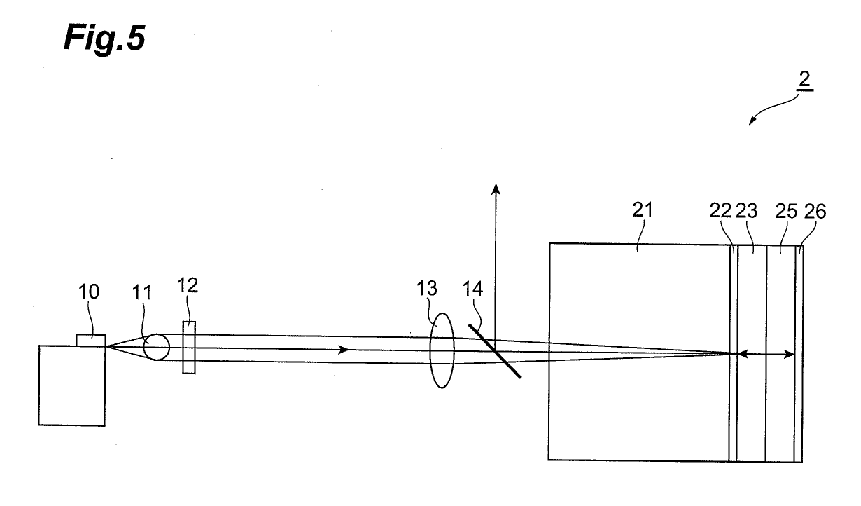

FIG. 5 is a view showing a configuration of a pulse laser light source 2 according to the second embodiment. The pulse laser light source 2 shown in the drawing is provided with an excitation light source 10, lenses 11 through 13, a dichroic mirror 14, an amplifier medium 21, a first reflection portion 22, a laser medium 23, a saturable absorber 25 and a second reflection portion 26.

If compared with the configuration of the pulse laser light source 1 according to the first embodiment shown in FIG. 1, the pulse laser light source 2 according to the second embodiment shown in FIG. 5 differs therefrom in that it does not include the third reflection portion 24. That is, the laser medium 23 and the saturable absorber 25 are directly bonded to each other. In addition, in the second embodiment, the reflection portion 26 reflects not only the emission light but also the excitation light at a high reflection index.

The pulse laser light source 2 according to the second embodiment operates as follows. Excitation light output from the excitation light source 10 is collimated by the two lenses 11 and 12, is converged by the lens 13, passes through the dichroic mirror 14 and is made incident into the amplifier medium 21. The excitation light made incident from the dichroic mirror 14 into the amplifier medium 21 passes through the amplifier medium 21, the reflection portion 22, the laser medium 23 and the saturable absorber 25 in order and reaches the reflection portion 26, and is reflected by the reflection portion 26. The excitation light reflected by the reflection portion 26 passes through the saturable absorber 25, the laser medium 23, the reflection portion 22 and the amplifier medium 21 in order. In the amplifier medium 21 and the laser medium 23, respectively, a photoactive substance is excited while the excitation light is passing therethrough.

In the laser resonator, the emission light generated in the laser medium 23 excited by the excitation light is able to reach the saturable resonator 25. When the power of the emission light generated in the laser medium 23 is small, the optical absorption index of the saturable absorber 25 is large, wherein no laser oscillation occurs in the laser resonator. As the light intensity in the saturable absorber 25 exceeds a specified value as the power of the emission light generated in the laser medium 23 is increased, the light absorption of the saturable absorber 25 is saturated, and the light absorption index rapidly is decreased. When the light absorption index of the saturable absorber 25 is decreased, the emission light generated in the laser medium 23 can pass through the saturable absorber 25, wherein the emission light reciprocates between the reflection portion 22 and the reflection portion 26, induced emission is brought about in the laser medium 23. Therefore, laser oscillation occurs in the laser resonator.

The light (laser light), which has passed through the reflection portion 22, of the induced emission light produced in the laser medium 23 is optically amplified in the amplifier medium 21 excited by the excitation light when it passes through the amplifier medium 21. And, the optically amplified laser light is emitted outside from the amplifier medium 21 and is reflected by the dichroic mirror 14. Also, as soon as such laser oscillation occurs, the power of the emission light generated in the laser medium 23 is decreased, and the optical absorption index of the saturable absorber 25 is increased, wherein the laser oscillation is finished in the laser resonator. By the above-described operation being repeated, the pulse laser light source 2 is able to output pulse laser light.

As in the pulse laser light source 1 according to the first embodiment, the pulse laser light source 2 according to the second embodiment is capable of outputting pulse laser light of high energy at a short pulse width.

### Third Embodiment

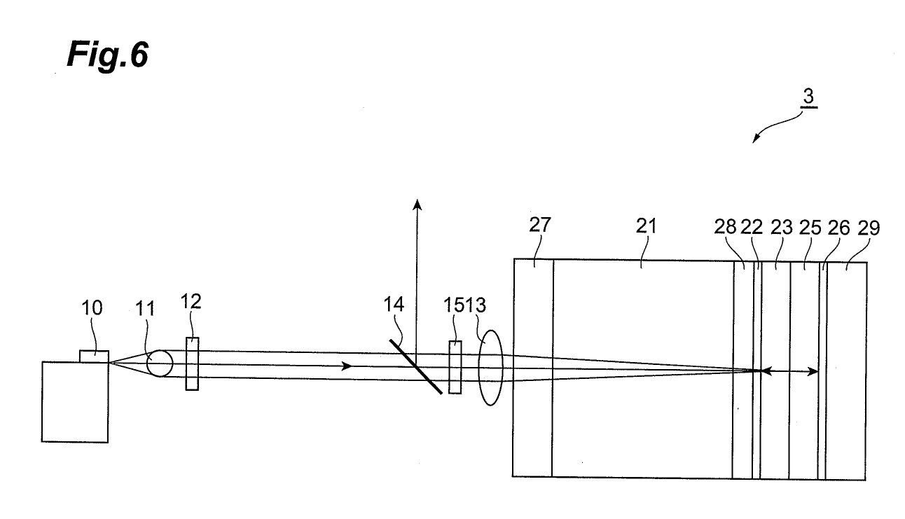

FIG. 6 is a view showing a configuration of a pulse laser light source 3 according to the third embodiment. The pulse laser light source 3 shown in the drawing is provided with an excitation light source 10, lenses 11 through 13, a dichroic mirror 14, a ¼ wavelength plate 15, an amplifier medium 21, a first reflection portion 22, a laser medium 23, a saturable absorber 25, a second reflection portion 26, and thermal diffusion portions 27 through 29.

If compared with the configuration of the pulse laser light source 2 according to the second embodiment shown in FIG. 5, the pulse laser light source 3 according to the third embodiment shown in FIG. 6 differs from the pulse laser light source 2 in that the ¼ wavelength plate 15 is further provided, and the thermal diffusion portions 27 through 29 are further provided.

The thermal diffusion portions 27 through 29 diffuse heat generated by optical absorption in the laser medium 21 or the saturable absorber 23. The thermal diffusion portions 27 through 29 are crystals not having any photoactive substance, and preferably are YAG. The thermal diffusion portion 27 is connected to one main side (the excitation light source 10 side) of the laser medium 21. The thermal diffusion portion 28 is provided between the laser medium 21 and the reflection portion 22. Also, the thermal diffusion portion 29 is connected to the saturable absorber 25 with the reflection portion 26 placed therebetween.

The thermal diffusion portion 27, the amplifier medium 21, the thermal diffusion portion 28, the first reflection portion 22, the laser medium 23, the saturable absorber 25, the second reflection portion 26 and the thermal diffusion portion 29 are disposed in order and are integrated with each other. When being integrated, it is preferable that these components are connected to each other by direct bonding (Surface-activating junction technique).

The ¼ wavelength plate 15 is provided between the dichroic mirror 14 and the amplifier medium 21. The dichroic mirror 14 causes p-polarization excitation light to pass therethrough and reflects s-polarization excitation light. The ¼ wavelength plate 15 has p-polarization excitation light, which has reached from the dichroic mirror 14, input therein, and outputs s-polarization excitation light to the dichroic mirror 14 by causing the excitation light to pass through two times.

The pulse laser light source 3 according to the third embodiment operates as follows. The excitation light output from the excitation light source 10 is collimated by the two lenses 11 and 12. The p-polarization components selectively pass through the dichroic mirror 14, and are made incident into the thermal diffusion portion 27 via the ¼ wavelength plate 15 and the lens 13. The excitation light made incident from the dichroic mirror 14 into the thermal diffusion portion 27 passes through the thermal diffusion portion 27, the amplifier medium 21, the thermal diffusion portion 28, the reflection portion 22, the laser medium 23 and the saturable absorber 25 in order, reaches the reflection portion 26, and is reflected by the reflection portion 26. The excitation light reflected by the reflection portion 26 passes through the saturable absorber 25, the laser medium 23, the reflection portion 22, the thermal diffusion portion 28, the amplifier medium 21 and the thermal diffusion portion 27 in order. In the amplifier medium 21 and the laser medium 23, respectively, the photoactive substance is excited when the excitation light passes therethrough. In addition, the excitation light, which has passed through the thermal diffusion portion 27, of the excitation light reflected by the reflection portion 26 is made into s-polarization by having passed through the ¼ wavelength plate 15, and is reflected by the dichroic mirror 14.

In the laser resonator, the emission light generated by the laser medium 23 excited by excitation light is able to reach the saturable absorber 25. When the power of the emission light generated in the laser medium 23 is small, the optical absorption index of the saturable absorber 25 is large, and no laser oscillation occurs in the laser resonator. As the power of the emission light generated in the laser medium 23 is increased, and the light intensity in the saturable absorber 25 exceeds a specified value, the optical absorption of the saturable absorber 25 is saturated, and the optical absorption index rapidly is decreased. When the optical absorption index of the saturable absorber 25 is decreased, the emission light generated in the laser medium 23 is able to pass through the saturable absorber 25, and reciprocates between the reflection portion 22 and the reflection portion 26, whereas induced emission is brought about in the laser medium 23. Therefore, laser oscillation occurs in the laser resonator.

Light (laser light), which has passed through the reflection portion 22, of the induced emission light produced in the laser medium 23 is optically amplified in the amplifier medium 21 excited by excitation light when it passes through the amplifier medium 21. And, the optically amplified laser light is emitted outside from the amplifier medium 21 via the thermal diffusion portion 27, and is reflected by the dichroic mirror 14. Also, as soon as such laser oscillation occurs, the power of the emission light generated in the laser medium 23 is decreased, and the optical absorption index of the saturable absorber 25 is increased, wherein the laser oscillation is finished in the laser resonator. By repeating such operations described above, the pulse laser light source 3 is able to output pulse laser light.

As in the pulse laser light source 2 according to the second embodiment, the pulse laser light source 3 according to the third embodiment is able to output pulse laser light of high energy with a short pulse width. In addition, in the pulse laser light source 3 according to the third embodiment, since the remaining excitation light not used for excitation in the amplifier medium 21 or the laser medium 23 is prevented from returning to the excitation light source 10, the pulse laser light source 3 is preferable in terms of protection of the excitation light source 10. Further, in the pulse laser light source 3 according to the third embodiment, since heat generated in the amplifier medium 21 or the laser medium 23 is diffused by the thermal diffusion portions 27 through 29, the thermal lens effect is prevented from occurring, and stabilized operation is enabled.

### Fourth Embodiment

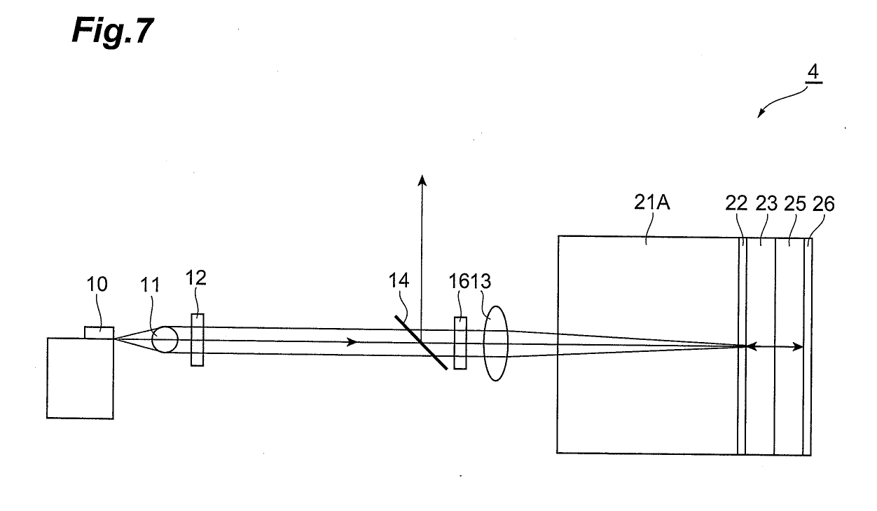

FIG. 7 is a view showing a configuration of a pulse laser light source 4 according to the fourth embodiment. The pulse laser light source 4 shown in the drawing is provided with an excitation light source 10, lenses 11 through 13, a dichroic mirror 14, a ½ wavelength plate 16, an amplifier medium 21A, a first reflection portion 22, a laser medium 23, a saturable absorber 25 and a second reflection portion 26.

If compared with the configuration of the pulse laser light source 2 according to the second embodiment shown in FIG. 5, the pulse laser light source 4 according to the fourth embodiment shown in FIG. 7 differs therefrom in that a ½ wavelength plate 16 is further provided, and an amplifier medium 21A is provided instead of the amplifier medium 21.

The amplifier medium 21A contains a photoactive substance, and the photoactive substance is excited by supplying excitation light output from the excitation light source 10. Emission light is generated from the photoactive substance. It is preferable that the amplifier medium 21A is composed of crystal such as Nd:YAG, Yb:YAG, etc. The thickness of the amplifier medium 21A is, for example, 0.2 mm through 1.5 mm. In particular, the amplifier medium 21A has an excitation light absorbing property depending on a polarization direction of the excitation light.

The ½ wavelength plate 16 is provided between the dichroic mirror 14 and the amplifier medium 21A. The ½ wavelength plate 16 is rotatable around the optical axis and operates as a polarization adjustment portion for adjusting the polarization state of the excitation light that is output from the excitation light source 10 and is made incident into the amplifier medium 21A.

That is, depending on the rotation direction of the ½ wavelength plate 16, absorption of the excitation light in the amplifier medium 21A differs, the gain of optical amplification of laser light in the amplifier medium 21A differs, and the pulse cycle of the laser oscillation also differs. For example, as absorption of the excitation light in the amplifier medium 21A is increased, the gain of the optical amplification of laser light in the amplifier medium 21A increases, and the pulse cycle of the laser oscillation is lengthened.

As in the pulse laser light source 2 according to the second embodiment, the pulse laser light source 4 according to the fourth embodiment is able to output pulse laser light of high energy with a short pulse width. In addition, in the pulse laser light source 4 according to the fourth embodiment, it is possible to modulate the pulse cycle of laser oscillation and the energy of pulse laser light in accordance with the rotation direction of the ½ wavelength plate 16.

### Fifth Embodiment

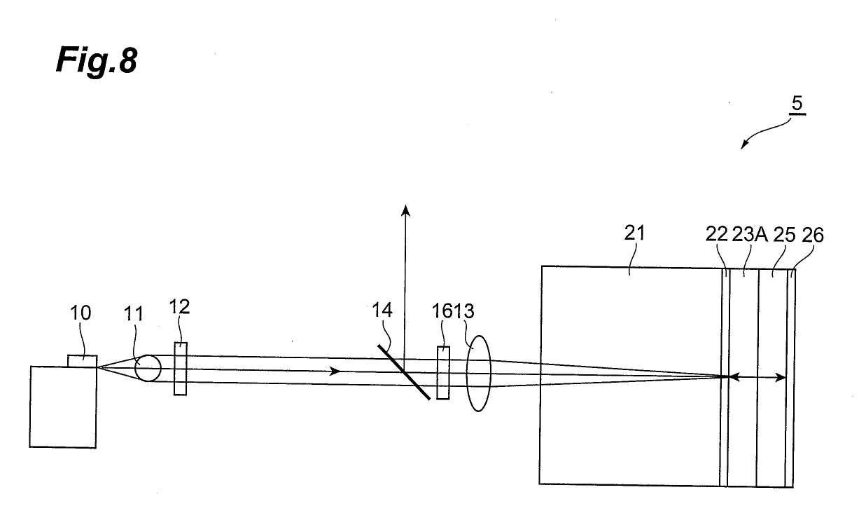

FIG. 8 is a view showing a configuration of a pulse laser light source 5 according to the fifth embodiment. The pulse laser light source 5 shown in the drawing is provided with an excitation light source 10, lenses 11 through 13, a dichroic mirror 14, a ½ wavelength plate 16, an amplifier medium 21, a first reflection portion 22, a laser medium 23A, a saturable absorber 25 and a second reflection portion 26.

If compared with the configuration of the pulse laser light source 2 according to the second embodiment shown in FIG. 5, the pulse laser light source 5 according to the fifth embodiment shown in FIG. 8 differs therefrom in that the ½ wavelength plate 16 is further provided, and that the laser medium 23A is provided instead of the laser medium 23.

The laser medium 23A contains a photoactive substance, and the photoactive substance is excited by supplying excitation light output from the excitation light source 10. Emission light is generated from the photoactive substance. It is preferable that the laser medium 23A is composed of crystal such as Nd:YAG, Yb:YAG, etc. The thickness of the laser medium 23A is, for example, 0.01 mm through 1.5 mm. In particular, the laser medium 23A has an excitation light absorbing property depending on a polarization direction of the excitation light.

The ½ wavelength plate 16 is provided between the dichroic mirror 14 and the amplifier medium 21A. The ½ wavelength plate 16 is rotatable around the optical axis and operates as a polarization adjustment portion for adjusting the polarization state of the excitation light that is output from the excitation light source 10 and is made incident into the amplifier medium 23A.

That is, depending on the rotation direction of the ½ wavelength plate 16, absorption of excitation light in the laser medium 23A differs, and the pulse cycle of the laser oscillation differs. For example, as the absorption of the excitation light in the laser medium 23A is increased, the pulse cycle of the laser oscillation is shortened. And, as the pulse cycle is shortened, the energy accumulated in the amplifier medium 21 per cycle is decreased, and the gain of optical amplification in the amplifier medium 21 decreases.

As in the pulse laser light source 2 according to the second embodiment, the pulse laser light source 5 according to the fifth embodiment is able to output pulse laser light of high energy with a short pulse width. In addition, in the pulse laser light source 5 according to the fifth embodiment, it is possible to modulate the pulse cycle of laser oscillation and the energy of pulse laser light in accordance with the rotation direction of the ½ wavelength plate 16.

A pulse laser apparatus according to the present invention is able to output pulse laser light of high energy with a short pulse width.

What is claimed is:

1. A pulse laser apparatus comprising:
an amplifier medium and a laser medium, which generate emission light by excitation light being supplied;
a saturable absorber, the light absorption index of which decreases by saturation of light absorption;
a first reflection portion for causing the excitation light to pass therethrough, causing a part of the emission light to pass therethrough, and reflecting the remaining thereof;
a second reflection portion for reflecting the emission light;
an excitation light source for outputting excitation light; and
an optical system for making excitation light, which is output from the excitation light source, incident into the amplifier medium, and guiding the emission light output from the amplifier medium to an optical path differing from the optical path of the excitation light,
wherein the first reflection portion and the second reflection portion compose a laser resonator having a laser medium and a saturable absorber on a resonance optical path, and
the amplifier medium, the first reflection portion, the laser medium, the saturable absorber, and the second reflection portion are disposed in order and are integrated with each other.

2. The pulse laser apparatus according to claim 1 further including a third reflection portion that is provided between the laser medium and the saturable absorber, reflects the excitation light and causes the emission light to pass therethrough.

3. The pulse laser apparatus according to claim 1, wherein the first reflection portion is composed of a dielectric multilayer film, and
the amplifier medium and the laser medium are directly bonded to each other with the first reflection portion placed therebetween.

4. The pulse laser apparatus according to claim 1, further including thermal diffusion portions that diffuse heat generated through optical absorption in the amplifier medium or the laser medium.

5. The pulse laser apparatus according to claim 1, wherein the amplifier medium has an excitation light absorbing property depending on a polarization direction of excitation light, and the optical system includes a polarization adjustment portion that adjusts the polarization state of excitation light output from the excitation light source and made incident into the amplifier medium.

6. The pulse laser apparatus according to claim 1, wherein the laser medium has an excitation light absorbing property depending on a polarization direction of excitation light, and
the optical system includes a polarization adjustment portion that adjusts the polarization state of excitation light output from the excitation light source and made incident into the amplifier medium.
